(19) United States
(12) Patent Application Publication
(10) Pub. No.: US 2025/0296859 A1
(43) Pub. Date: Sep. 25, 2025

(54) WATER IONIZER

(71) Applicant: Main Access, Avon, OH (US)

(72) Inventor: Todd KREINBRINK, Avon, OH (US)

(21) Appl. No.: 19/083,976

(22) Filed: Mar. 19, 2025

Related U.S. Application Data
(60) Provisional application No. 63/567,148, filed on Mar. 19, 2024.

(51) Int. Cl. C02F 1/461; C02F 103/42; E04H 4/12

(52) U.S. Cl. CPC C02F 1/4618; E04H 4/1218; C02F 2103/42; C02F 2201/004; C02F 2201/006

(57) ABSTRACT

Disclosed herein are devices and methods relating to a water ionizer and using the water ionizer to treat pool water. The water ionizer includes a housing having a waterflow channel and electrode receptacle; and an electrode cartridge having a body and pair of electrodes. The electrode cartridge may be removably attached to the housing. The water ionizer is automatically activated by a piezo switch or vibration sensor that senses water flowing through the waterflow channel and between the pair of electrodes. The electrodes are charged causing ions to jump between electrodes. During the jump the ions are caught by the flowing water. The automatic activation/deactivation of the water ionizer allows a user to adjust the copper in the pool water to the ideal level of 0.3-0.5 PPM by adjusting the schedule of the pool's circulation system. The removability of the electrode cartridge allows the user to easily replace the electrodes.

### BACKGROUND

The present disclosure relates to devices and methods for ionizing water and simplified maintenance of same. More particularly, swimming pool ionizers and the replacement of their electrodes.

Water ionizers are commonly used for treating swimming pool water. Typically, water ionizers have a pair of electrodes within a pipe where water can flow in the pipe and between the electrodes. As voltage is developed between the electrodes, ions attempt to jump from one electrode to the other. As water flows through the pipe and between the electrodes the ions are diverted and thus ionize the water. Copper electrodes are often used as copper is toxic to various types of bacteria and plant life. Therefore, ionizing pool water with copper or similar ions helps reduce the growth of algae and bacteria.

U.S. Pat. No. 4,713,170 discloses a swimming pool water ionization system. The system includes a T-shaped pipe with an input, output and central opening. A pressure fitting is secured to the central opening and an assembly containing electrodes is placed in the pressure fitting and secured with PVC cement or caulking. A sleeve is then inserted and cemented or caulked in place with a cap then placed on said sleeve. Thus, replacing the electrodes once they wear out can be a lengthy and labor intensive process.

U.S. Pat. No. 5,893,977 discloses a swimming pool water ionizer including an enclosure and an electrode housing. The electrode housing includes a hollow cylindrical body and a projection. Water flows through the hollow cylindrical body and between the electrodes that are sealed within the projection. Because the electrodes are sealed within the projection the entire electrode housing must be replaced when the electrodes need to be replaced. This causes additional waste, but also requires the user to disconnect the water ionizer from the pool's filtration system during replacement.

Therefore, there exists a need for a water ionizer which has easily replaceable electrodes without significant additional waste.

### BRIEF DESCRIPTION

Disclosed in various embodiments are water ionizers having a housing and an electrode cartridge. The housing having a waterflow channel and electrode receptacle; the electrode cartridge having a body and a pair of electrodes. The electrode cartridge may be removably connected to the housing. The removable attachment of the electrode cartridge to the housing ensures the correct orientation of the pair of electrodes as they extend through the electrode receptacle and into the waterflow channel.

Electrode cartridges for use in a water ionizer are also disclosed. The electrode cartridge may include an outer body and an inner body which are rotatably connected.

In some embodiments the electrode cartridge has an alignment guide to assist the correct orientation of the electrodes in the waterflow channel. The alignment guide may be generally cylindrical in shape with at least one cutout, to allow for correct orientation with one or more flat spots in the electrode receptacle.

In certain embodiments the electrode cartridge may include an O-ring to ensure a watertight seal with the housing.

In other embodiments the housing may include a well which may house a thermometer, a piezo switch, or a vibration sensor.

Methods of ionizing water are also disclosed. These methods may include the use of any of the disclosed embodiments of water ionizers or electrode cartridges and activating the water ionizer as water runs between the electrodes.

Methods of refilling a water ionizer are also disclosed. These methods may include the use of any of the disclosed embodiments of water ionizers or electrode cartridges. The methods disclose the disconnecting of a used electrode cartridge and connecting a new electrode cartridge.

In some embodiments the water ionizer may remain connected to a pool filtration system during the replacement of the electrode cartridge.

Pools using any of the disclosed embodiments of a water ionizer are also disclosed.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a front perspective view of the water ionizer.

FIG. 2 is a bottom perspective view of the water ionizer.

FIG. 3 is a front view of the water ionizer.

FIG. 4 is a rear view of the water ionizer.

FIG. 5 is a top view of the water ionizer.

FIG. 6 is a bottom view of the water ionizer.

FIG. 7 is a bottom perspective view of the electrode cartridge.

FIG. 8 is a top perspective view of the electrode cartridge.

FIG. 9 is a front view of the electrode cartridge rotated on its side.

FIG. 10 is a bottom view of the electrode cartridge.

FIG. 11 is a top view of the electrode cartridge.

FIG. 12 is a first side view of the electrode cartridge.

FIG. 13 is a bottom view of the housing.

FIG. 14 is a first side view of the water ionizer.

FIG. 15 is a second side view of the water ionizer.

FIG. 16 is a bottom perspective exploded view of the water ionizer.

### DETAILED DESCRIPTION

A more complete understanding of the components and devices disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

The term “comprising” is used herein as requiring the presence of the named components/steps and allowing the presence of other components/steps. The term “comprising” should be construed to include the term “consisting of”, which allows the presence of only the named components/steps.

Numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

A value modified by a term or terms, such as “about” and “substantially,” may not be limited to the precise value specified. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number.

The terms “top” or “upper” and “bottom” or “lower” are used to refer to locations/surfaces where the top/upper is always higher than the bottom/lower relative to an absolute reference, i.e. the surface of the earth. The terms “upwards” and “downwards” are also relative to an absolute reference; upwards is always against the gravity of the earth.

The terms “horizontal” and “vertical” are used to indicate direction relative to an absolute reference, i.e. ground level. However, these terms should not be construed to require structures to be absolutely parallel or absolutely perpendicular to each other. For example, a first vertical structure and a second vertical structure are not necessarily parallel to each other.

U.S. Pat. No. 4,713,170 discloses a swimming pool water treatment system, the disclosure of which is herein incorporated by reference.

The present invention provides an improved water treatment system.

The present invention provides a water treatment system which can operate in the presence or absence of water treated with cyanuric acid and other substances which affect the resistivity of the water.

The present invention provides a compact water treatment system which can be readily installed in a small space without requiring a change in water direction.

The present invention provides a water treatment system which can be installed without drainage of the swimming pool.

The present invention provides an improved electro-chemical water treatment system which has reduced break-in cost as a result of the ability to function in the presence of low resistivity water.

The present invention provides a replaceable anode-cathode assembly for use in an electrolytic water treatment system in accord with the present water treatment system.

The present invention provides an improved method for conditioning and breaking in the water of a swimming pool for use of an electrolytic water treatment system.

The present invention provides a water treatment system which overcomes the disadvantages present in other such devices.

In one embodiment of the present invention an improved electro-chemical apparatus for treating swimming pool water and inhibiting the growth of algae therein includes a substantially T-Shaped hollow pipe fitting having first and second opposing openings and a central opening substantially normal to the first and second openings, the first opening being suitable for receiving a flow of water and the second opening being suitable for discharging the flow of water. A pressure fitting is coupled to and seals the central opening. An electrical anode, consisting essentially of copper and having a first major axis, is coupled to the pressure fitting and situated within the pipe fitting with the first major axis approximately normal to the flow of water. An electrical cathode having a second major axis, is disposed adjacent the anode with the second major axis approximately parallel to the first major axis. An electrical circuit applies an electrical current between the anode and the cathode.

In another embodiment of the present invention, an improved method of treating water for a swimming pool during a period of transition to a treatment system utilizing copper electrolysis for treating said water, includes the steps of:
establishing or maintaining a concentration of chlorine stabilizer in the water suitable for inhibiting breakdown of chlorine in the water;
applying a first electrical current between an anode consisting essentially of copper and a cathode to initiate copper electrolysis;
monitoring the level of copper trisulphate in the water at approximately weekly intervals to determine the level of copper in the water; and
adding decreasing amounts of chlorine to the water for approximately 4 weeks to maintain a concentration of at least 1.0 to 1.5 PPM of chlorine during the first week decreasing to approximately 0.2 to 0.5 PPM of chlorine when the copper trisulphate level reaches approximately 0.2 to 0.4 PPM. Preferably, a sequestering agent is also used to keep the copper suspended in the water.

The present disclosure relates to a water ionizer, ease of water ionizer maintenance and related methods. The contemplated water ionizer provides a simplified means to change the electrodes as needed, creating a more user-friendly experience and less waste.

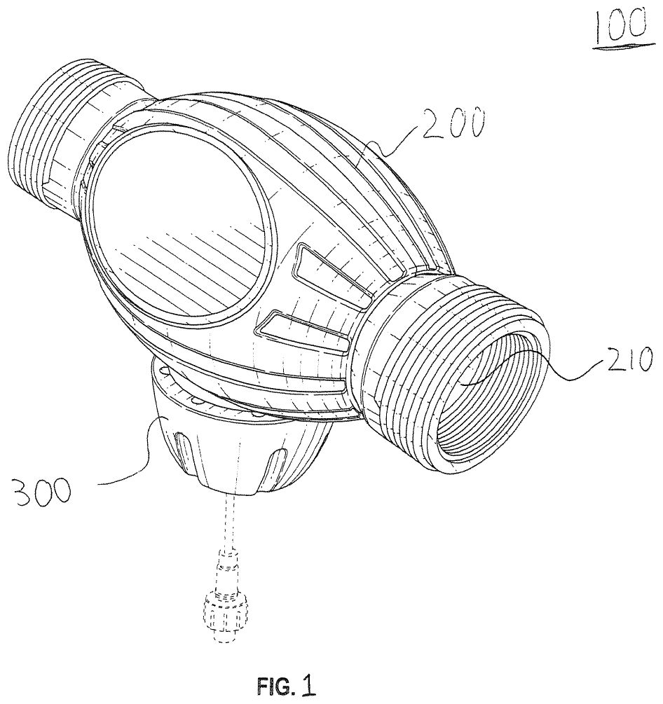

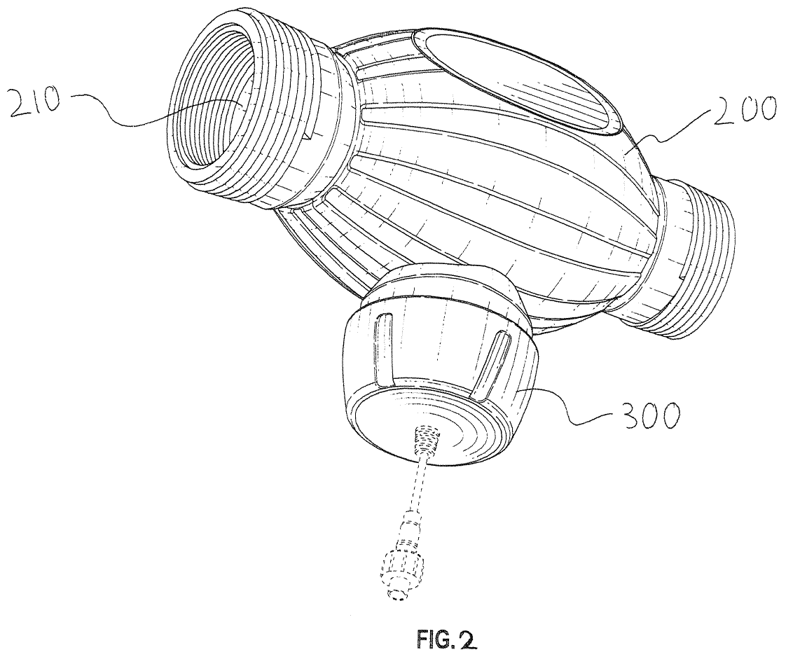

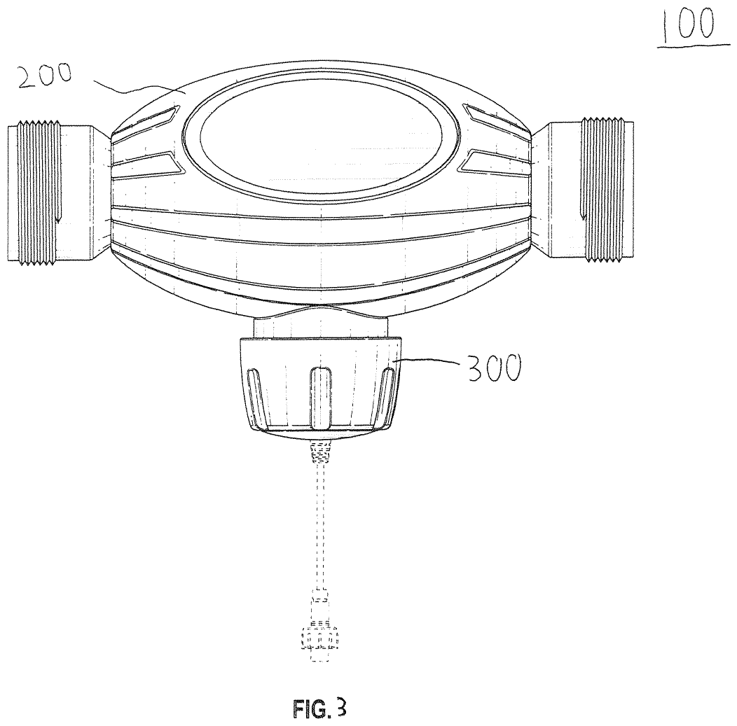

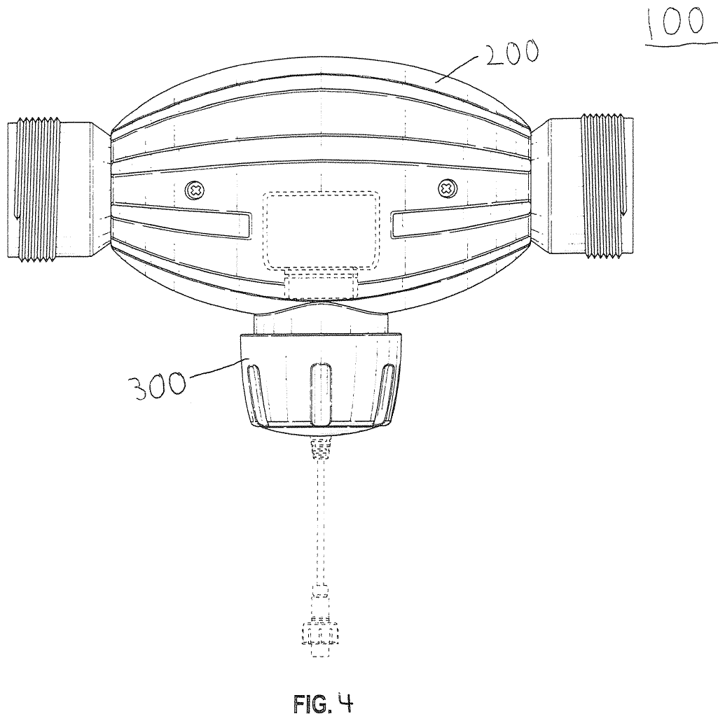

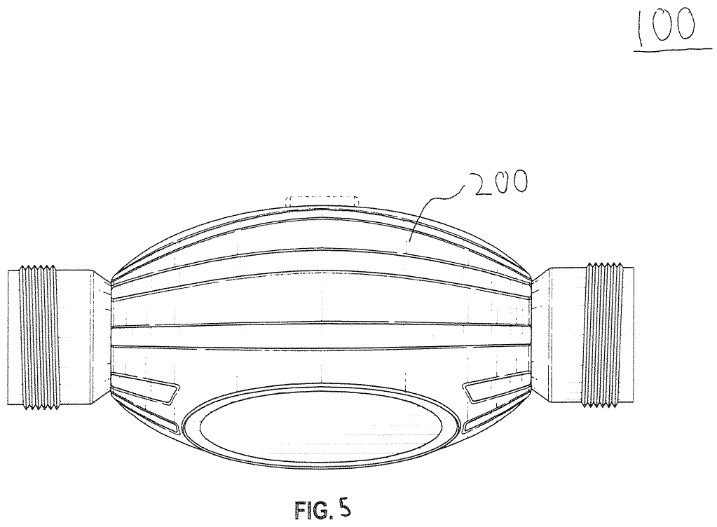

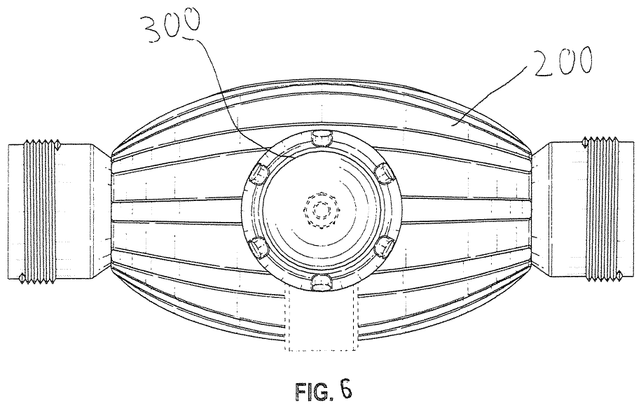

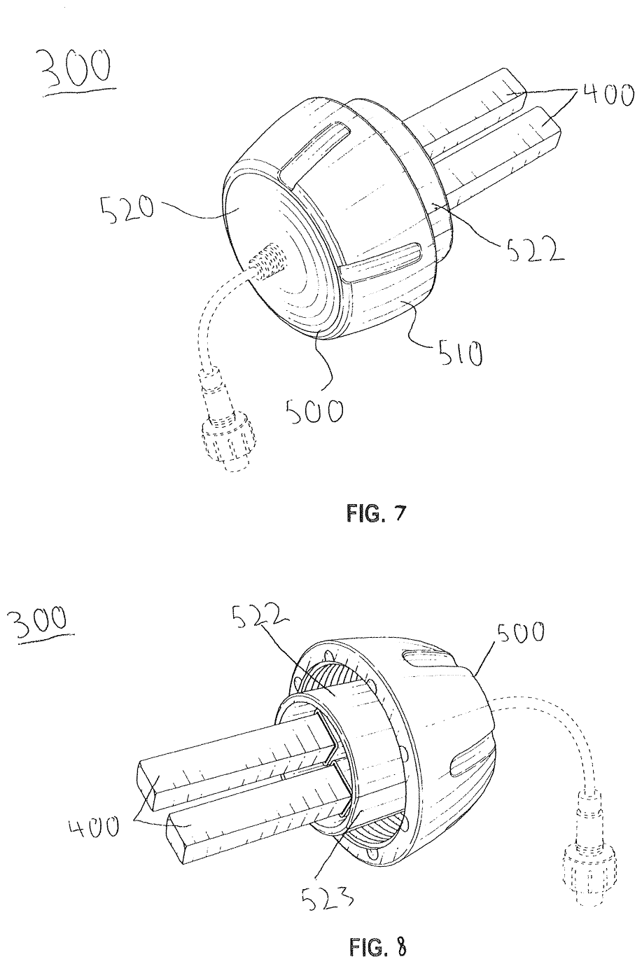

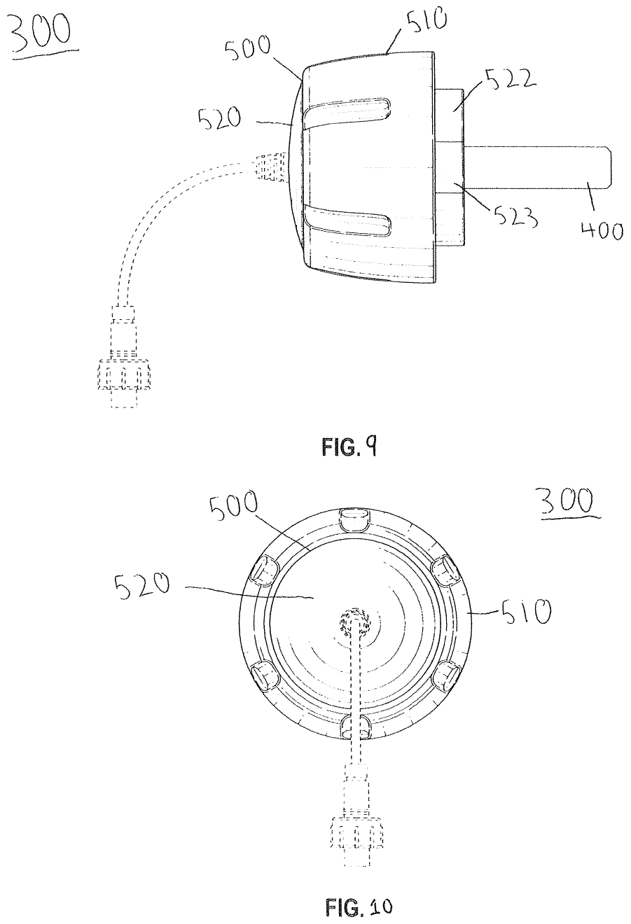

FIG. 1 is a first side top perspective view of the water ionizer 100. The housing 200 can be seen with a waterflow channel 210 running through it. An electrode cartridge 300 can be seen removably connected to the housing 200. FIG. 2 is a second side bottom perspective view of the water ionizer 100 with the waterflow channel 210 running through the housing 200 with the electrode cartridge 300 removably attached to the housing 200. FIGS. 3-6 show front, rear, top, and bottom views of the water ionizer 100 with the electrode cartridge 300 removably connected to the housing 200.

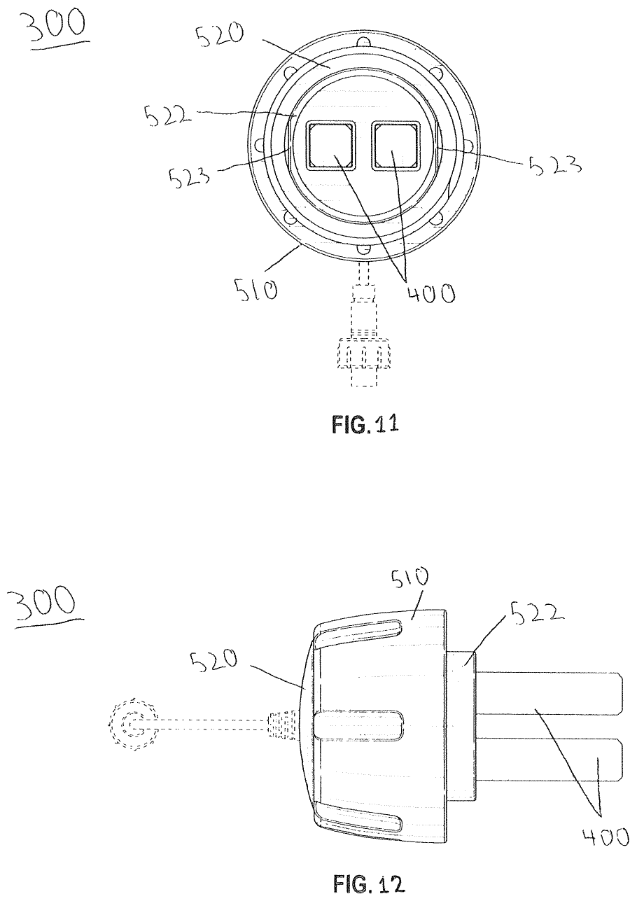

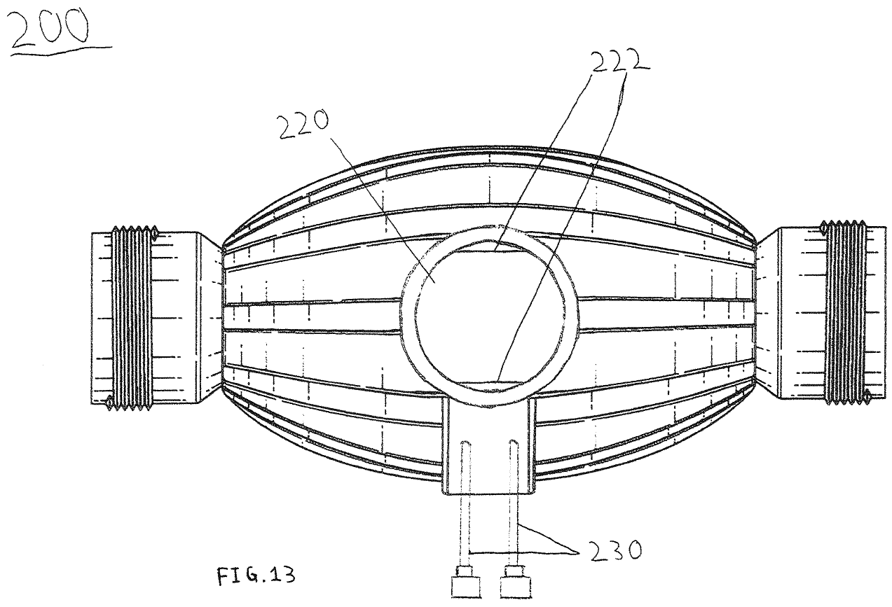

FIGS. 7-12 show the electrode cartridge 300 from various angles and sides. The body 500 can be seen with outer body 510 and inner body 520. The outer body 510 and inner body 520 may be rotatable connected. The pair of electrodes 400 and alignment guide 522 can be seen connected to the inner body 520. In some embodiment's the alignment guide 522 may have a generally cylindrical shape with one or more cutouts 523, as seen in FIGS. 8,9, and 11. The one or more cutouts 523 may correspond to one or more flat spots 222 on the electrode receptacle 220. These one or more flat spots 222 may be seen in FIG. 13.

FIG. 13 is a bottom view of the housing 200. The electrode receptacle 220 can be seen with one or more flat spots 222. A pair of wires 230 can be seen running from the housing. The pair of wires 230 may be used to transfer power or information. In some embodiments one of the wires may be used to transfer power while the other transfers information. In certain embodiments the wires may be connected to a thermometer, piezo switch, or vibration sensor. The piezo switch or vibration sensor may allow the water ionizer 100 to be automatically activated when the pool's filtration circulation system is running and automatically deactivated when the pool's filtration circulation system stops running. The automatic activation/deactivation of the water ionizer 100 allows a user to achieve the ideal copper level in the pool water of 0.3 to 0.5 parts per million by adjusting the run times of the pool's filtration circulation system.

Referring to FIGS. 8, 9, 11 and 13 together, the matching cutouts 523 and flat spots 222 together ensure that as the electrode cartridge 300 is inserted into the housing 200 the pair of electrodes 400 remain in the correct orientation. While the shown embodiment uses two cutouts 523 matching two flat spots 222, in some embodiments there may only be one corresponding cutout 523 and flat spot 222. In other embodiments there may be more than two corresponding cutouts 523 and flat spots 222. While the use of cutouts 523 and flat spots 222 is shown, other corresponding geometry between the alignment guide 522 and electrode receptacle 220 is also considered. Such other geometry may include tongue and groove, spline, and visual indicators.

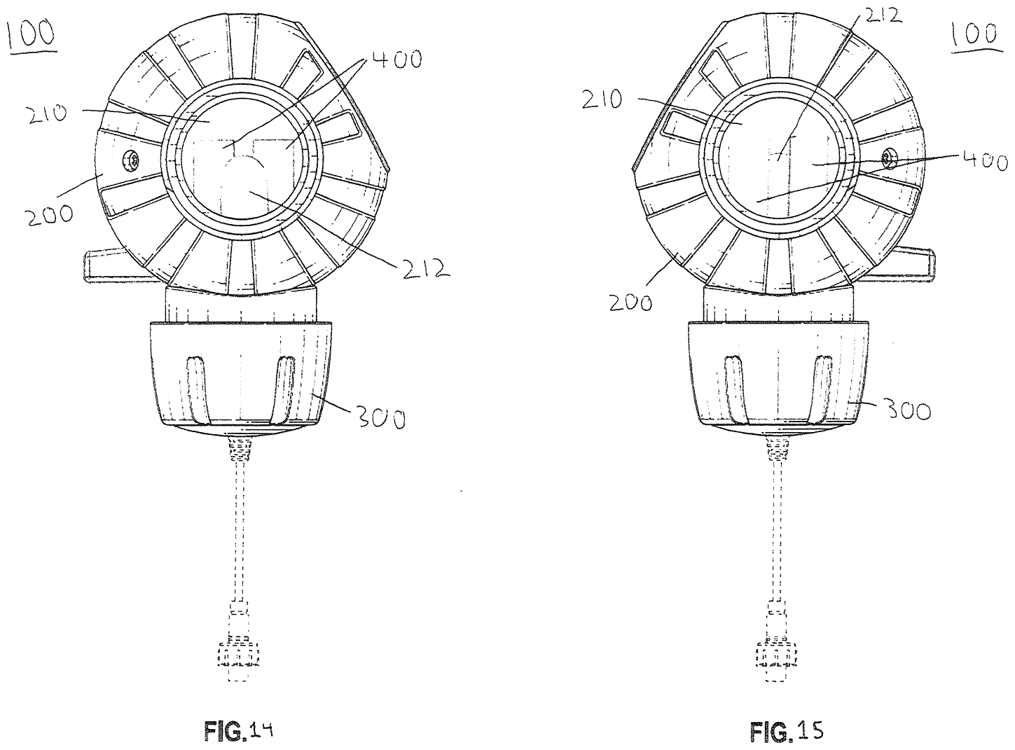

FIGS. 14-15 show the water ionizer 100 from a first side and a second side respectively. Referring to both figures together, the electrode cartridge 300 can be seen removably connected to the housing 200. A pair of electrodes 400 can be seen extending from the electrode cartridge 300 and partially into the waterflow channel 210. The pair of electrodes 400 may develop a voltage and cause ions to jump from one electrode to the other. As ions try to jump from one electrode to the other, the ions will be caught by water flowing through the waterflow channel 210 and between the pair of electrodes 400 thus ionizing the water. A well 212 can also be seen in the waterflow channel 210. In some embodiments the well 212 may include a thermometer to measure the temperature of the water flowing through the waterflow channel 210. In certain embodiments, the well 212 may include a piezo switch that can activate the water ionizer 100 when the pool's filtration system causes water to flow through the waterflow channel 210. In other embodiments the well 212 may include a vibration sensor that senses when water is flowing through the waterflow channel 210 and cause the water ionizer 100 to activate. In particular embodiments the well 212 may include any combination of a thermometer, a piezo switch, and a vibration sensor.

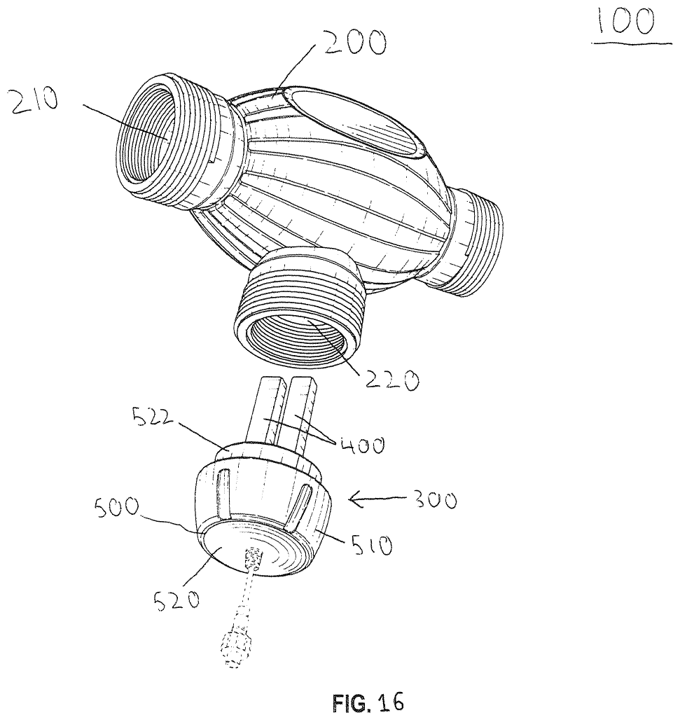

FIG. 16 shows a bottom perspective exploded view of the water ionizer 100. The housing 200 can be seen with waterflow channel 210 and electrode receptacle 220. The electrode cartridge 300 can be seen with body 500 and pair of electrodes 400. The body 500 has outer body 510 and inner body 520 which are rotatably connected. The pair of electrodes 400 is connected to the inner body 520. An alignment guide 522 is also connected to the inner body 520. The pair of electrodes 400 and alignment guide 522 being both connected to the inner body 520 remain fixed relative to each other.

The alignment guide 522 has geometry that corresponds to the geometry of the electrode receptacle 220 so that as the electrode cartridge 300 is removably connected to the housing 200 the pair of electrodes 400 remain in the proper orientation.

In the shown embodiments, the electrode cartridge 300 is connected to the housing 200 by the outer body 510 and the housing 200 having a screw connection. During the connection, the alignment guide 522 is inserted into the electrode receptacle 220 and the outer body 510 is rotated relative to the housing 200. The corresponding geometry of the alignment guide 522 and the electrode receptable 220 prevent the alignment guide 522, inner body 520, and pair of electrodes 400 from rotating relative to the housing 200 as the outer body 510 is rotated relative to the housing 200. Once the electrode cartridge 300 is connected to the housing 200 the pair of electrodes 400 extend through the electrode receptacle 220 and at least partially into the waterflow channel 210. The alignment guide's 522 prevention of the pair of electrodes 400 from rotating relative to the housing 200 during the connection of the electrode cartridge 300 to the housing 200 ensures that the pair of electrodes 400 are perpendicular to the waterflow channel's 210 longitudinal axis. This perpendicular orientation ensures that water flowing through the waterflow channel 210 can flow between the pair of electrodes 400.

In some embodiments an O-ring may be used in the electrode cartridge 300 to ensure a watertight connection to the housing 200. The O-ring may be squeezed between the inner body 520 and a portion of the electrode receptacle 220 in order to prevent water from escaping.

Methods of ionizing water are also disclosed. Such methods include providing a water ionizer 100 consistent with the present disclosure, activating the water ionizer 100 as water flows through a waterflow channel 210 and through a pair of electrodes 400.

Methods of refilling a water ionizer 100 are also disclosed. Such methods include providing a water ionizer 100 consistent with the present disclosure, disconnecting a used electrode cartridge 300 from the housing 200 and connecting a new electrode cartridge 300 to the housing 200. In some embodiments the water ionizer 100 may remain connected to a pool filtration circulation line while the used electrode cartridge 300 is removed and replaced with a new one.

A pool including a water ionizer 100 consistent with the present disclosure is also disclosed. The water ionizer 100 may be connected to the pool's water filtration circulation system.

The present disclosure has been described with reference to exemplary embodiments. Modifications and alterations will occur to others upon reading and understanding the preceding detailed description. It is intended that the present disclosure be construed as including all such modifications and alterations insofar as they come within the scope of the appended claims or the equivalents thereof.

1. A water ionizer comprising:
a housing comprising:
a waterflow channel, and
an electrode receptacle;
an electrode cartridge, the electrode cartridge comprising:
a body,
a pair of electrodes;
wherein the electrode cartridge is removably connected to the housing, the pair of electrodes extending at least partially into the waterflow channel when the electrode cartridge is connected to the housing.

2. The water ionizer of claim 1, wherein the removable connection between the electrode cartridge and the housing is a screw connection.

3. The water ionizer of claim 1, wherein the electrode cartridge body comprises an inner body and an outer body.

4. The water ionizer of claim 3, wherein the electrode cartridge inner body and outer body are rotatably connected.

5. The water ionizer of claim 4, wherein the pair of electrodes are connected to the electrode cartridge inner body.

6. The water ionizer of claim 5, wherein the electrode cartridge inner body includes an alignment guide.

7. The water ionizer of claim 6, wherein the alignment guide and pair of electrodes are fixed relative to each other.

8. The water ionizer of claim 7, wherein the geometry of the alignment guide corresponds to the geometry of the electrode receptacle.

9. The water ionizer of claim 8, wherein the geometry of the alignment guide and electrode receptacle ensure that the pair of electrodes remain perpendicular to a longitudinal axis of the waterflow channel when the electrode cartridge body is connected to the housing.

10. The water ionizer of claim 6, wherein the alignment guide is generally cylindrical.

11. The water ionizer of claim 10, wherein the alignment guide includes at least one cutout.

12. (canceled)

13. An electrode cartridge for use in a water ionizer comprising:
a body comprising:
an inner body, and
an outer body;
a pair of electrodes.

14. The electrode cartridge of claim 11, wherein the inner body and outer body are rotatable connected.

15. The electrode cartridge of claim 11, wherein the pair of electrodes are connected to the inner body.

16. The electrode cartridge of claim 11, further comprising an alignment guide.

17. The electrode cartridge of claim 11, wherein the inner body includes an alignment guide.

18. The electrode cartridge of claim 17, wherein the alignment guide and electrodes are fixed relative to each other.

19. (canceled)

20. A method of ionizing water comprising the steps of:
providing a water ionizer having a housing, the housing having a waterflow channel and electrode receptacle;
providing an electrode cartridge having a body and a pair of electrodes;
removably attaching the electrode cartridge to the housing, with the pair of electrodes extending through the electrode receptacle and into the waterflow channel, with the pair of electrodes oriented perpendicular to the waterflow channel;
activating the water ionizer as water runs through the waterflow channel and between the pair of electrodes.

21. (canceled)

22. (canceled)

23. (canceled)

24. (canceled)

25. (canceled)

26. (canceled)

27. (canceled)

28. (canceled)

29. (canceled)

30. A method of refilling a water ionizer comprising the steps of:
providing the water ionizer of claim 1;
disconnecting a spent electrode cartridge;
connecting a fresh electrode cartridge.

31. The method of claim 30, wherein the waterflow channel remains connected to a pool filtration circulation line during refilling.

32. (canceled)
